(19) United States
(12) Patent Application Publication
(10) Pub. No.: US 2019/0309968 A1
(43) Pub. Date: Oct. 10, 2019

(54) THERMAL MANAGEMENT SYSTEM WITH THERMOGRAPHIC SENSING

(71) Applicant: Carrier Corporation, Palm Beach Gardens, FL (US)

(72) Inventors: Chandra Shekhar Nalajala, Andhra Pradesh (IN); Srinivas Padilam, Ramakrishna Puram (IN); Manoj Kumar Gannabathula, Madinaguda (IN)

(21) Appl. No.: 16/014,165

(22) Filed: Jun. 21, 2018

(30) Foreign Application Priority Data
Apr. 5, 2018 (IN) 201811012946

(51) Int. Cl. F24F 11/30; F24F 11/523; F24F 11/56; F24F 11/74; G06T 7/00

(52) U.S. Cl. CPC F24F 11/30; F24F 11/523; G06T 2207/10048; F24F 11/74; G06T 7/97; F24F 11/56

(57) ABSTRACT

According to an aspect, a method of thermal management includes capturing one or more thermal images within a temperature-controlled space, using a thermal imaging camera. One or more sources of radiant heat are identified within the temperature-controlled space based on the one or more thermal images. A heat level variation of the one or more sources is determined with respect to an ambient temperature of the temperature-controlled space. A control action of a heating, ventilation, and air-conditioning system is triggered in response to the heat level variation.

### CROSS-REFERENCE TO RELATED APPLICATION

This application claims the benefit of the IN Application No. 201811012946 filed Apr. 5, 2018, which is incorporated herein by reference in its entirety.

### BACKGROUND

The subject matter disclosed herein generally relates to the field of heating, ventilation, and air-conditioning (HVAC) systems, and more particularly to thermal management of HVAC systems with thermographic sensing.

Heat loads within temperature-controlled spaces can vary based on a number of factors, such as radiant heat generated or received within the spaces. Radiant heat sources can include light fixtures, electronic devices, windows, doors, people, pets, and other such sources. HVAC systems typically include one or more temperature sensors and control units, such as thermostats, to assist in making control decisions for increasing or decreasing/stopping a ventilation flow of warmed or cooled air. The placement of temperature sensors in proximity to radiant heat sources can impact heating and cooling within the temperature-controlled spaces and may impact occupant comfort. Further, radiant heat loads can impact the energy efficiency of HVAC systems.

### BRIEF SUMMARY

According to one embodiment, a method of thermal management includes capturing one or more thermal images within a temperature-controlled space, using a thermal imaging camera. One or more sources of radiant heat are identified within the temperature-controlled space based on the one or more thermal images. A heat level variation of the one or more sources is determined with respect to an ambient temperature of the temperature-controlled space. A control action of an HVAC system is triggered in response to the heat level variation.

In addition to one or more of the features described above, or as an alternative, further embodiments may include tracking the heat level variation of the one or more sources with respect to time to identify at least one temperature trend, and triggering the control action in response to a detected change in the at least one temperature trend.

In addition to one or more of the features described above, or as an alternative, further embodiments may include where identifying the one or more sources of radiant heat includes identifying one or more locations of the one or more sources of radiant heat within the temperature-controlled space.

In addition to one or more of the features described above, or as an alternative, further embodiments may include classifying the one or more sources of radiant heat based on the heat level variation.

In addition to one or more of the features described above, or as an alternative, further embodiments may include where the classifying includes distinguishing human heat generation patterns from non-human heat generation patterns.

In addition to one or more of the features described above, or as an alternative, further embodiments may include where the control action is a flow adjustment to target one or more locations corresponding to the human heat generation patterns.

In addition to one or more of the features described above, or as an alternative, further embodiments may include where the control action includes sending an alert message to one or more user interfaces indicating an observed condition and recommended action.

According to another embodiment, a thermal management system that includes an HVAC system configured to control environmental conditions within a temperature-controlled space. A thermal imaging camera is configured to capture one or more thermal images within a temperature-controlled space. A controller is in electronic communication with the HVAC system and the thermal imaging camera. The controller includes a processing system and a memory system including computer-executable instructions that, when executed by the processing system cause, the processing system to perform operations. The operations include identifying one or more sources of radiant heat within the temperature-controlled space based on the one or more thermal images, determining a heat level variation of the one or more sources with respect to an ambient temperature of the temperature-controlled space, and triggering an adjustment of the HVAC system in response to the heat level variation.

In addition to one or more of the features described above, or as an alternative, further embodiments may include tracking the heat level variation of the one or more sources with respect to time to identify at least one temperature trend, and triggering the adjustment in response to a detected change in the at least one temperature trend.

In addition to one or more of the features described above, or as an alternative, further embodiments may include where the adjustment includes a flow adjustment to target one or more locations corresponding to the human heat generation patterns.

According to another embodiment, a thermal management system includes an HVAC system configured to control environmental conditions within a temperature-controlled space, a thermal imaging camera configured to capture one or more thermal images within a temperature-controlled space, and a controller in electronic communication with the HVAC system and the thermal imaging camera. The controller includes a processing system and a memory system comprising computer-executable instructions that, when executed by the processing system, cause the processing system to perform operations. The operations include identifying one or more sources of radiant heat within the temperature-controlled space based on the one or more thermal images, determining a heat level variation of the one or more sources with respect to an ambient temperature of the temperature-controlled space, and sending an alert message to one or more user interfaces associated with the HVAC system indicating an observed condition and recommended action in response to the heat level variation.

In addition to one or more of the features described above, or as an alternative, further embodiments may include tracking the heat level variation of the one or more sources with respect to time to identify at least one temperature trend, and triggering the alert message in response to a detected change in the at least one temperature trend.

Technical effects of embodiments of the present disclosure include capturing thermal images within a temperature-controlled space and triggering a control action of an HVAC system in response to the thermal images.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

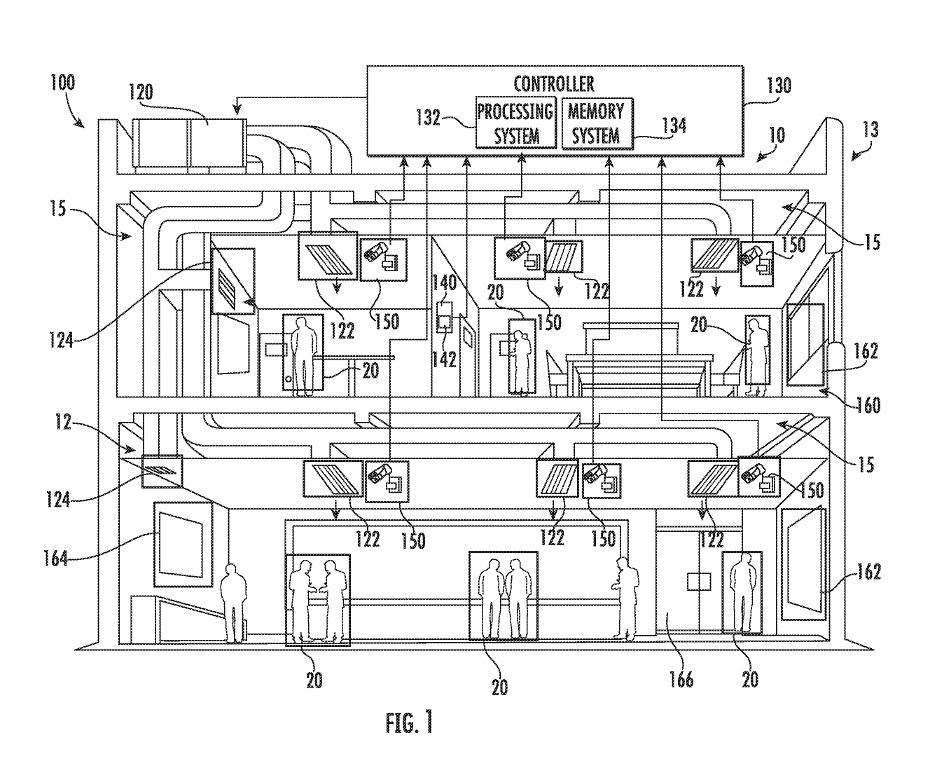

FIG. 1 illustrates a general schematic system diagram of a thermal management system, in accordance with an embodiment of the disclosure;

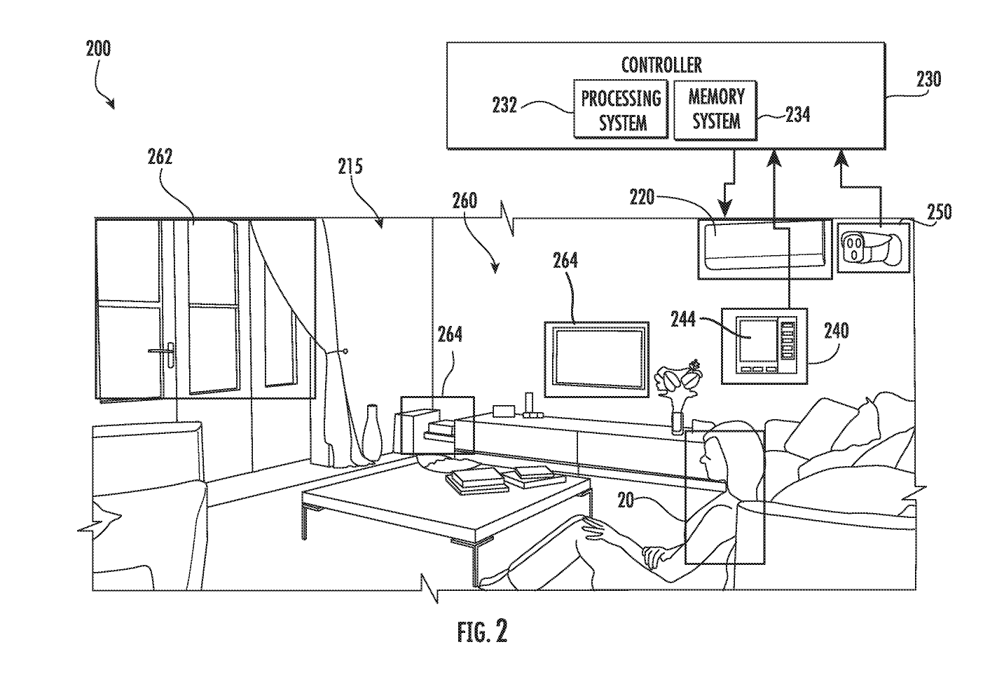

FIG. 2 illustrates a general schematic system diagram of a thermal management system, in accordance with an embodiment of the disclosure;

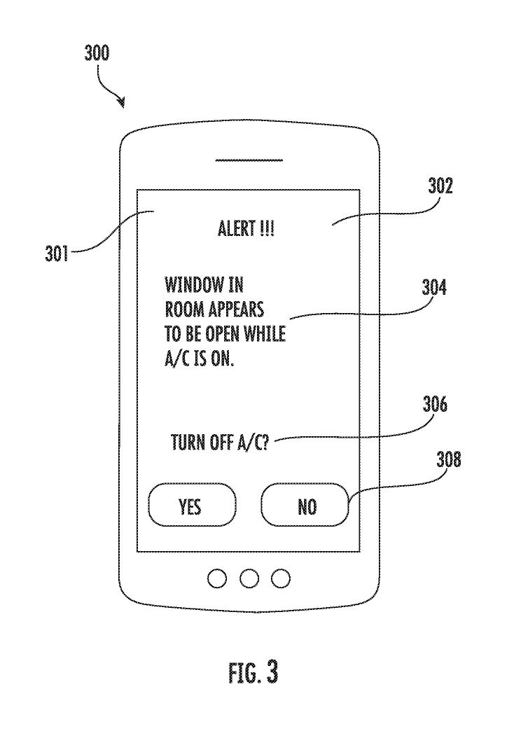

FIG. 3 illustrates a user interface, in accordance with an embodiment of the disclosure; and

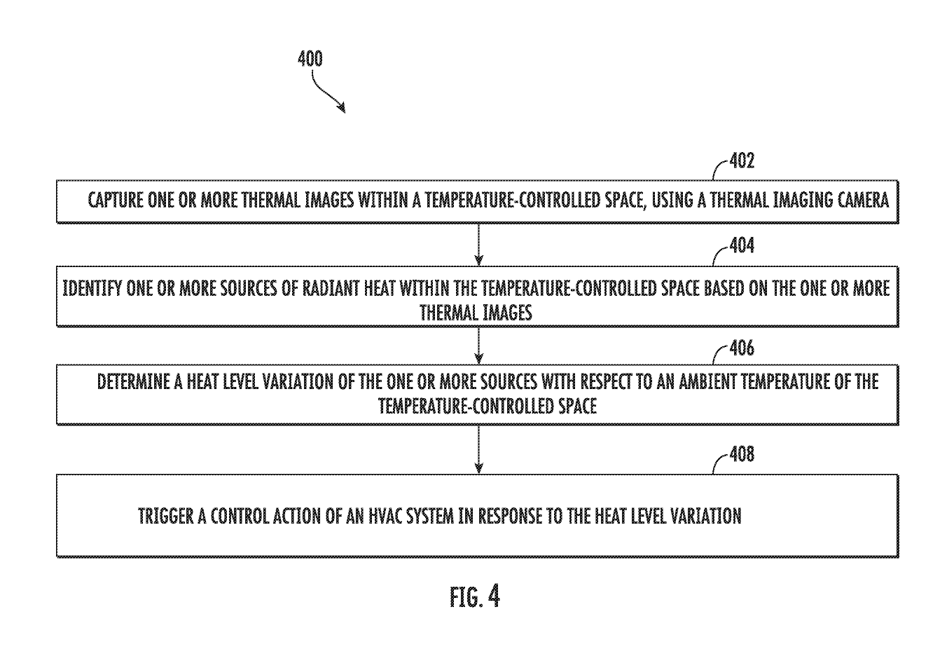

FIG. 4 is a flow diagram illustrating a method of thermal management, according to an embodiment of the present disclosure.

### DETAILED DESCRIPTION

A detailed description of one or more embodiments of the disclosed apparatus and method are presented herein by way of exemplification and not limitation with reference to the Figures.

As will be described below, a heating, ventilation, and air-conditioning (HVAC) system for a temperature-controlled space is provided. Embodiments disclosed herein relate to controlling various operations of the HVAC system to maintain desired environmental conditions in the temperature-controlled space using a thermal imaging camera. Embodiments can also trigger alerts to one or more user interfaces indicating an observed condition and recommended action. In some instances, the HVAC system or a linked home automation system can perform the recommended action. In other instances, the action is a prompt for a person to perform a manual action, such as closing a window or blinds.

With reference to FIG. 1, a thermal management system 100 is illustrated, in accordance with an embodiment of the present disclosure. As seen in FIG. 1, a structure 10 is provided and may be configured as a residence, an industrial building, an office building, a commercial building, or other enclosures known in the art. For purposes of clarity and brevity, however, the following description will relate to the case where the structure 10 is configured as an office building but it is understood that embodiments disclosed herein are not limited to an office building. The structure 10 includes an interior 12 separated from an exterior 13. The interior 12 may be further divided into multiple rooms and areas for various purposes in the illustrated example of FIG. 1, referred to as one or more temperature-controlled spaces 15.

The thermal management system 100 includes an HVAC system 120 disposed and configured to control environmental conditions within the one or more temperature-controlled spaces 15. The HVAC system 120 is configured to condition the air within the one or more temperature-controlled spaces 15 by means of controlling the volume of heated or cooled air supplied to the one or more temperature-controlled spaces 15. Some examples of the HVAC system 120 may include but are not limited to a forced air system, a heat pump, a fan, a radiator, a fireplace, a pellet stove, a wood stove, a water mister, or any other device known to one of skill in the art to control thermal comfort. The HVAC system 120 may include a return conduit 124 and a supply 122 to aid in the circulation of air within the one or more temperature-controlled spaces 15. In the example of FIG. 1, one or more of the supplies 122 are split wing rotation systems operable to change air distribution direction responsive to one or more commands in a split air system configuration.

The thermal management system 100 also includes a controller 130 configured for controlling thermal comfort of occupants 20 within the interior 12. The controller 130 is in electronic communication with the HVAC system 120 and controls the operations of the HVAC system 120 to provide and maintain a desired thermal environment and thermal comfort level within the one or more temperature-controlled spaces 15. The electronic communication may be wired and/or wireless. The controller 130 may be an electronic controller including a processing system 132 and a memory system 134 including computer-executable instructions that, when executed by the processing system 132, cause the processing system 132 to perform various operations. The processing system 132 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory system 134 may be a storage device such as, for example, a random access memory (RAM), read only memory (ROM), or other electronic, optical, magnetic or any other computer readable storage medium.

The thermal management system 100 can also include a system control device 140 (e.g., a thermostat) in electronic communication with the controller 130. The electronic communication between the system control device 140 and the controller 130 may be wired and/or wireless. In a non-limiting embodiment, the system control device 140 may be a mobile application installed on a smart phone and/or a device attached within the interior 12. The system control device 140 may be generally accessible to an occupant 20 and is configured to control various operations of the HVAC system 120 to maintain desired environmental conditions in the interior 12. The system control device 140 may also include a sensor 142 configured to detect environmental conditions in the interior 12, such as, for example, temperature, humidity, pressure, luminous flux, and/or any environmental condition known to one of skill in the art.

The following description will also relate to the cases in which the system control device 140 is wirelessly communicative with the controller 130. This is described for clarity and brevity and is not intended to otherwise limit the scope of the application as a whole. The system control device 140 may have the capability to establish and maintain wireless connectivity over various networks (e.g., Wi-Fi, Bluetooth, Z-Wave, ZigBee, etc.). The system control device 140 can therefore be connected to a local Wi-Fi network and the Internet. This may allow the system control device 140 to have additional features and capabilities including, but not limited to, being remotely controllable by a user using the portable computing device (e.g., a mobile phone, a tablet, a laptop, etc.). The system control device 140 may also have a second private wireless communication link operative through any type of network with the controller 130. In addition, the link between the controller 130 and the system control device 140 may be developed to automatically pair and connect.

The thermal management system 100 also includes one or more thermal imaging cameras 150 in electronic communication with the controller 130. The electronic communication between the thermal imaging cameras 150 and the controller 130 may be wired and/or wireless. One or more of the thermal imaging cameras 150 may be configured to visually recognize a feature, such as a face or body of an occupant 20, and capture a thermal image of the occupant 20. The thermal imaging cameras 150 may also be configured to visually recognize a region on the occupant 20 as a likely human pattern, and capture a thermal image of the occupant 20. The thermal imaging cameras 150 are positioned in the interior 12 so that they may capture thermal images of the occupants 20 and other heat sources as sources 160 of radiant heat, such as one or more windows 162 and electronics 164 (including lighting), and doors 166. The sources 160 of radiant heat can add heat unevenly within the one or more temperature-controlled spaces 15. For example, the sources 160 of radiant heat may congregate closer to the system control device 140 or be grouped further from the system control device 140 such that the heating effects are not evenly felt be occupants 20 or observed by the system control device 140 throughout the temperature-controlled spaces 15.

In a non-limiting example, the thermal imaging cameras 150 can be located on a wall and/or ceiling of temperature-controlled spaces 15 to capture thermal images of multiple occupants 20. There may be multiple thermal imaging cameras 150 utilized in each of the temperature-controlled spaces 15. The controller 130 can analyze captured images from the thermal imaging cameras 150 to determine trends, heat patterns, object classification, and other information as further described herein.

The following description will also relate to the cases in which the thermal imaging cameras 150 are wirelessly communicative with the controller 130. This is described for clarity and brevity and is not intended to otherwise limit the scope of the application as a whole. The thermal imaging cameras 150 may have the capability to establish and maintain wireless connectivity over various networks (e.g., Wi-Fi, Bluetooth, Z-Wave, ZigBee, etc.). The thermal imaging cameras 150 can therefore be connected to a local Wi-Fi network and the Internet. The thermal imaging cameras 150 may also have a second private wireless communication link operative along any type of network with the controller 130. In addition, the links between the controller 130 and the thermal imaging cameras 150 can be developed to automatically pair and connect.

The thermal imaging cameras 150 are configured to transmit thermal images to the controller 130. The controller 130 is configured to analyze thermal images and identify one or more sources 160 of radiant heat within the temperature-controlled spaces 15. For example, heat patterns or signatures can be used to distinguish the occupants 20 from the windows 162 and/or electronics 164. Heat signatures at the windows 162 can vary based on the time or day, weather conditions, and whether the windows 162 are opened or closed. Heat signatures of the electronics 164 can change depending on an ON/OFF state of the electronics 164 and can also vary depending on a workload and other factors. Occupants 20 can have shape parameters that define a range of expected physical proportions, heat level, and position variations. For instance, in tracking size and movement of a heat signature pattern over a period of time, human heat generation patterns can be distinguished from not non-human heat generation patterns.

In embodiments, an adjustment of the HVAC system 120 can be triggered in response to a heat level variation. For instance, if a heat load associated with sources 160 of radiant heat is grouped at a location within the one or more temperature-controlled spaces 15, the one or more of the thermal imaging cameras 150 can observe an increased heat trend of heat patterns of the sources 160 of radiant heat. Upon identifying a change/increase in heat at a location, the controller 130 can adjust one or more wings of the supply 122 through the HVAC system 120 to target a cooling air flow to the location with increased radiant heat. Thus, a comfort level of occupants 20 can be improved by targeting the delivery of cooling air without changing a set point for the associated temperature-controlled space 15.

With reference to FIG. 2, a thermal management system 200 is depicted as an alternate embodiment of the thermal management system 100 of FIG. 1, with like numbers indicating similar features. For example, the thermal management system 200 can include an HVAC system 220 disposed and configured to control environmental conditions within the one or more temperature-controlled spaces 215. The HVAC system 220 is configured to condition the air within the one or more temperature-controlled spaces 215 by means of controlling the volume of heated or cooled air supplied to the one or more temperature-controlled spaces 215. The example of FIG. 2, the HVAC system 220 can be sized for residential use, such as within a room of a home rather than an office or industrial environment.

The thermal management system 200 also includes a controller 230 configured for controlling thermal comfort of occupants 20 within one or more temperature-controlled spaces 215. The controller 230 may be an electronic controller including a processing system 232 and a memory system 234 similar to the controller 130 of FIG. 1. A system control device 240 can include a user interface 244 and establish electronic communication with the controller 230. The controller 230 can also communicate with one or more mobile devices 300 of FIG. 3 to generate alerts and/or receive commands. In some embodiments, a structure may contain multiple instances of the system control device 240, such that a status at one location can be observed and/or controlled at another location. For example, an instance of the system control device 240 installed on an upper level of a building/home can be used to observe and/or adjust environmental conditions on a lower level of the same building/home.

The thermal management system 200 also includes one or more thermal imaging cameras 250 in electronic communication with the controller 230. The controller 230 can analyze captured images from the thermal imaging cameras 250 to determine trends, heat patterns, object classification, and other information as further described herein.

The controller 230 is configured to analyze thermal images and identify one or more sources 260 of radiant heat within the temperature-controlled spaces 215. For example, heat patterns or signatures can be used to distinguish the occupants 20 from windows 262 and/or electronics 264. Heat signatures at the windows 262 can vary based on the time of day, weather conditions, and whether the windows 262 are opened or closed. Heat signatures of the electronics 264 can change depending on an ON/OFF state of the electronics 264 and can also vary depending on a workload and other factors. Further examples of the sources 260 of radiant heat which may be distinguishable relative to occupants 20 can include doors, light fixtures, and other such heat emitting objects. Occupants 20 can have shape parameters that define a range of expected physical proportions, heat level, and position variations. For instance, in tracking size and movement of a heat signature pattern over a period of time, human heat generation patterns can be distinguished from not non-human heat generation patterns. The controller 230 can monitor for heat level variation of the one or more sources 260 with respect to an ambient temperature of the temperature-controlled space 215. An alert message can be sent to one or more user interfaces 244 associated with the HVAC system 220 indicating an observed condition and recommended action in response to the heat level variation. The alert message can include a request to approve an action or can include a request to perform an action. The action may be directly performed by the HVAC system 220, relayed to another system, such as a home automation system (not depicted), or performed by a person.

FIG. 3 illustrates a user interface 301 of a mobile device 300 that is an embodiment of the user interface 244 of FIG. 2. In the example of FIG. 3, the user interface 301 displays an alert message 302 including an observed condition 304 and recommended action 306 in response to the heat level variation. The recommended action 306 can include selection options 308, such as a ‘Yes’ option and a ‘No’ option. It will be understood that the example of FIG. 3 is non-limiting and many variations of the user interface 301 are possible. For instance, the recommended action 306 can be a prompt for the user to take further actions.

Referring now to FIG. 4 with continued reference to FIGS. 1-3. FIG. 4 depicts a flow chart of a method 400 of thermal management in accordance with an embodiment of the disclosure. The method 400 can be performed by the controller 130, 230, and/or other elements of the thermal management system 100, 200. At block 402, one or more thermal images are captured by one or more thermal imaging cameras 150, 250 within a temperature-controlled space 15, 215. In some embodiments, prior to capturing the thermal image, the thermal imaging cameras 150 may visually recognize a face of a first one of the occupants 20. The thermal imaging cameras 150, 250 may transmit the thermal image to the controller 130, 230.

At block 404, one or more sources 160, 260 of radiant heat are identified within the temperature-controlled space 15, 215 based on the one or more thermal images. The one or more sources 160, 260 of radiant heat can include identifying one or more locations of the one or more sources 160, 260 of radiant heat within the temperature-controlled space 15, 215.

At block 406, a heat level variation of the one or more sources 160, 260 can be determined with respect to an ambient temperature of the temperature-controlled space 15, 215. The one or more sources 160, 260 of radiant heat can be classified based on the heat level variation. The classifying can include distinguishing human heat generation patterns from non-human heat generation patterns.

At block 408, a control action of a HVAC system 120, 220 can be triggered in response to the heat level variation. The controller 130, 230 may also track the heat level variation of the one or more sources with respect to time to identify at least one temperature trend. For instance, a temperature change trend observed where windows 162, 262 are located can be used to distinguish between a likely opened or likely closed condition. The control action can be triggered in response to a detected change in the at least one temperature trend. The control action can be a flow adjustment to target one or more locations corresponding to the human heat generation patterns. The control action may include sending an alert message 302 to one or more user interfaces 244, 301 indicating an observed condition 304 and recommended action 306.

The HVAC system 120, 220 may be adjusted by increasing cooling output of the HVAC system 120, 220 when a comfort level is determined to be greater than a comfort range (i.e., warmer than a comfort range). The HVAC system 120, 220 may be adjusted by increasing heat output of the HVAC system 120, 220 when a comfort level is determined to be less than a comfort range (i.e., colder than a comfort range). A wing position of a supply 122 can be adjusted responsive to locations and/or preferences associated with temperature conditions at the sources 160 of radiant heat. The HVAC system 120, 220 may be turned off responsive to a response to the recommended action 306. In some embodiments, the controller 130, 230 prompts a user to consider taking actions, such as turning off the electronics 162, 262, closing one or more of the windows 164, 264, shutting blinds or shades, turning off lighting in unoccupied spaces, and other such actions.

While the above description has described the flow process of FIG. 4 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of thermal management, the method comprising:
capturing one or more thermal images within a temperature-controlled space, using a thermal imaging camera;
identifying one or more sources of radiant heat within the temperature-controlled space based on the one or more thermal images;
determining a heat level variation of the one or more sources with respect to an ambient temperature of the temperature-controlled space; and
triggering a control action of a heating, ventilation, and air-conditioning (HVAC) system in response to the heat level variation.

2. The method of claim 1, further comprising:
tracking the heat level variation of the one or more sources with respect to time to identify at least one temperature trend; and
triggering the control action in response to a detected change in the at least one temperature trend.

3. The method of claim 1, wherein identifying the one or more sources of radiant heat comprises identifying one or more locations of the one or more sources of radiant heat within the temperature-controlled space.

4. The method of claim 3, further comprising:
classifying the one or more sources of radiant heat based on the heat level variation.

5. The method of claim 4, wherein the classifying comprises distinguishing human heat generation patterns from non-human heat generation patterns.

6. The method of claim 5, wherein the control action is a flow adjustment to target one or more locations corresponding to the human heat generation patterns.

7. The method of claim 1, wherein the control action comprises sending an alert message to one or more user interfaces indicating an observed condition and recommended action.

8. A thermal management system, comprising:
a heating, ventilation, and air-conditioning (HVAC) system configured to control environmental conditions within a temperature-controlled space;
a thermal imaging camera configured to capture one or more thermal images within a temperature-controlled space; and
a controller in electronic communication with the HVAC system and the thermal imaging camera, the controller comprising:
a processing system; and
a memory system comprising computer-executable instructions that, when executed by the processing system, cause the processing system to perform operations, the operations comprising:
identifying one or more sources of radiant heat within the temperature-controlled space based on the one or more thermal images;
determining a heat level variation of the one or more sources with respect to an ambient temperature of the temperature-controlled space; and
triggering an adjustment of the HVAC system in response to the heat level variation.

9. The thermal management system of claim 8, wherein the controller is further configured to perform the operations comprising:
tracking the heat level variation of the one or more sources with respect to time to identify at least one temperature trend; and
triggering the adjustment in response to a detected change in the at least one temperature trend.

10. The thermal management system of claim 8, wherein identifying the one or more sources of radiant heat comprises identifying one or more locations of the one or more sources of radiant heat within the temperature-controlled space.

11. The thermal management system of claim 10, wherein the controller is further configured to perform the operations comprising:
classifying the one or more sources of radiant heat based on the heat level variation.

12. The thermal management system of claim 11, wherein the classifying comprises distinguishing human heat generation patterns from non-human heat generation patterns.

13. The thermal management system of claim 12, wherein the adjustment comprises a flow adjustment to target one or more locations corresponding to the human heat generation patterns.

14. A thermal management system comprising:
a heating, ventilation, and air-conditioning (HVAC) system configured to control environmental conditions within a temperature-controlled space;
a thermal imaging camera configured to capture one or more thermal images within a temperature-controlled space; and
a controller in electronic communication with the HVAC system and the thermal imaging camera, the controller comprising:
a processing system; and
a memory system comprising computer-executable instructions that, when executed by the processing system, cause the processing system to perform operations, the operations comprising:
identifying one or more sources of radiant heat within the temperature-controlled space based on the one or more thermal images;
determining a heat level variation of the one or more sources with respect to an ambient temperature of the temperature-controlled space; and
sending an alert message to one or more user interfaces associated with the HVAC system indicating an observed condition and recommended action in response to the heat level variation.

15. The thermal management system of claim 14, wherein the controller is further configured to perform the operations comprising:
tracking the heat level variation of the one or more sources with respect to time to identify at least one temperature trend; and
triggering the alert message in response to a detected change in the at least one temperature trend.

16. The thermal management system of claim 14, wherein identifying the one or more sources of radiant heat comprises identifying one or more locations of the one or more sources of radiant heat within the temperature-controlled space.

17. The thermal management system of claim 16, wherein the controller is further configured to perform the operations comprising:
classifying the one or more sources of radiant heat based on the heat level variation.

18. The thermal management system of claim 17, wherein the classifying comprises distinguishing human heat generation patterns from non-human heat generation patterns.
